(19) United States
(12) Patent Application Publication
(10) Pub. No.: US 2010/0306017 A1
(43) Pub. Date: Dec. 2, 2010

(54) CREATING, CONFIRMING, AND MANAGING EMPLOYEE SCHEDULES

(76) Inventors: Jacob A. Dreyfuss, Elkins Park, PA (US); Joel A. Frisch, Cheltenham, PA (US)

Correspondence Address: SCULLY SCOTT MURPHY & PRESSER, PC, 400 GARDEN CITY PLAZA, SUITE 300, GARDEN CITY, NY, 11530, US

(21) Appl. No.: 12/472,813

(22) Filed: May 27, 2009

(51) Int. Cl. G06Q 10/00; G06F 15/16

(52) U.S. Cl. 705/9; 709/206

(57) ABSTRACT

A system and method for creating, confirming and managing employee schedules comprises creating a schedule having time slots comprising shifts having employees, publishing the schedule on a network to the employees, and receiving a response of a confirmation, a request for shift change, and a null response from each employee. For each employee, if a null response is received, a reminder is sent. If request for shift change is received, an alert is sent to eligible employees using a preferred communication mode, and if one of the eligible employees responds, the shift change may be confirmed automatically or with manager approval. If approved, the employee requesting the change and the eligible employee are notified of the change; if not approved, both employees are notified of the lack of change. The schedule can be published using an employee's preferred communication mode. All steps contain implications for the system's three-step color-coding schema.

### FIELD OF THE INVENTION

The present disclosure relates generally to automated scheduling, and more particularly to scheduling, confirmation, and management of employee work shifts.

### BACKGROUND OF THE INVENTION

Managing workers and activities in a commercial environment can be complex, especially when dealing with a variety of jobs, employees, roles and skills. Currently most companies with hourly workers use white boards, EXCEL spreadsheets or paper to track their schedules. A smaller percentage use available scheduling software.

### SUMMARY OF THE INVENTION

A system and method for creating, confirming, and managing employee schedules is provided. The system and method comprises creating a schedule having time slots comprising shifts having employees, publishing the schedule on a two-way communication network to the employees, and receiving a response of a confirmation, a request for shift change, and a null response from each employee. For each employee, if a null response is received, a reminder is sent. If confirmation is received, it is saved in the schedule. If request for shift change is received, an alert is sent to eligible employees using a preferred communication mode, and if one of the eligible employees responds, the shift change may be confirmed automatically or with manager approval. If approved, both the employee requesting the change and the eligible employee are notified of the change; if not approved, both employees are notified of the lack of change. The schedule can be published using an employee's preferred communication mode.

Schedule creation, confirmation and management is enhanced by a three-step color-coding system such that various steps in the process impact the color of the schedule, improving the management capabilities of an administrator or manager by making potential problem areas easy to detect. In one embodiment, the schedule is initially red. When a time slot containing jobs and employee shifts is added to the schedule, it changes to yellow, and when all employee shifts in a time slot are confirmed, the time slot color changes to green. In one embodiment, publishing can change the color of the schedule.

Creating the schedule further comprises steps of: establishing one or more jobs, and the plurality of time slots having employee shifts; and assigning at least one employee to each shift based on a job of the employee. Assigning can be performed using an auto-fill feature. When the assigning is completed, the schedule can change color, for example from red to yellow. The communication network can be web-based. Publishing can be performed by sending an alert to each employee using a preferred communication mode of the employee. The response can be sent on the communication network.

A program storage device readable by a machine, tangibly embodying a program of instructions executable by the machine to perform methods described herein may also be provided.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a flow diagram illustrating a method of the present disclosure in one embodiment.

FIG. 2 is a flow diagram of the scheduling process performed by a manager in an exemplary embodiment of the system;

FIG. 3 is a flow diagram of the employee confirmation process performed by a manager in an exemplary embodiment of the system;

FIG. 4 is a flow diagram of the shift changing process performed by a manager in an exemplary embodiment of the system;

FIG. 5 is a flow diagram of the messaging component of the inventive system; and

FIG. 6 is an exemplary screen display of messaging.

### DETAILED DESCRIPTION

The inventive system and method comprises a two-way, web based communication software tool for scheduling staff, such as workers or employees. Managers of establishments with staffs, including restaurants, hotels, call centers, retail stores, trucking companies and others, not only need to efficiently schedule employees, but also need a high level of accountability from their employees to know that they will show up for work as assigned. Accordingly, these managers require the ability to alert and remind employees of their shifts, that is their assignments to perform a particular job in a particular time slot, to ensure staff will come to work for their next shift. Further, the ability for staff to communicate back with management is necessary.

The innovative staff scheduling system and method includes drag and drop capabilities, recognizable color coding, and two-way SMS-Text messaging features that facilitate more efficient scheduling, greater communication between employees and managers, better employee accountability, and increased overall profitability for companies. An exemplary embodiment includes two way, web-based communication software having “drag and drop” functionality, color coded screens employing a three-step color-coding schema for prioritizing decision making, real time schedule updates enabling managers to always remain up to date, and robust communication features among managers and employees, such as two way text messaging for changes and reminders. The system can be implemented using software such as AJAX, .NET, HTML, VB.NET and AQL Server 2005. However, the system is not limited to this software.

In the inventive system, many scheduling operations or functions that are usually handled by a manager can be handled by the employee. Activities such as shift changing, vacation time, and schedule distribution can be performed by the employee. Managers can still choose to approve certain actions; however the responsibility lies with the employee.

Users will have multiple channels to communicate with other users within the system. Users will be able to generate emails, text messages and announcement posts through the system. In one embodiment, the system behaves like a desktop application, while staying as scalable and easily deployable as a web application. Users can interact with the system through three distinct channels, scheduling, messaging, and managing. Most user-system interaction can occur via a web site, which typically provides the greatest amount of functionality. In addition, users can execute certain functions through text messaging and email. Email interaction and text message interaction can function similarly, as follows. The user will be asked a question, to which he or she may respond. Email responses will be facilitated through hyperlinks. Text message response will occur using a coded response, such as a binary response: 1=yes, 2=no.

In order to minimize the amount of user error and training, the system's web interface can be extremely intuitive and mostly graphical. Color coding and icons will be used throughout the web site interface to allow users to easily identify system components and functionality.

The features and functions of an exemplary embodiment of the inventive system are now described. Functions can include, but are not limited to, functions for performing maintenance of user accounts, jobs and roles. Additional application or system functions can perform activities such as scheduling, alerting, reporting, and application security. Almost all functions have validation as discussed below.

User roles define the functions and features that an individual user can perform in the inventive system. In one embodiment, three user roles are defined: administrator, manager, and employee. Users having the administrator role (administrator) can have access to all system functions; this role can typically be given to the owner of one or more establishments. Users having the manager role (manager) can have access to system functions only at the single establishment he or she manages. This can enable the manager to perform functions such as create and publish schedules, and assign time slots to employees. A user whose account has a role of employee (employee) has access to the functions as discussed below.

Other user roles may be created if needed. The Create Role function allows an administrative user, e.g., administrator or manager, to create a new user role. The Delete Role function allows an administrative user to delete a role from the system. Validation will prevent a role that is in use, such as still assigned to users, from being deleted. Typically these functions are performed only during system set-up.

The Assign Role to User function allows an administrative user to assign an existing role to an existing user account, often enabling the user of that account to perform additional functions. The Remove Role from User Account function allows an administrative user to remove a role from a user account. For example, when a user is no longer employed at an establishment, his or her role can be removed from her user account. The List Roles Assigned to User Accounts function allows an administrative user to list all roles assigned to a particular user account.

The system is accessed via user accounts by which a user connects or logs into the system. Each user of the system, regardless of role, has an individual user account. In one embodiment, fees for using the system are assessed by user account per establishment.

Account maintenance can be performed using the following functions. The Create User Account function creates a new user account. A user can “Register”, creating his or her personal user account, or a user account may be created by another user. In most cases, this account is assigned a role.

The Delete User Account function allows a manager or administrator to delete a user account. Validation will be used to determine if deletion of the user account is permitted. Such validation could include, for example, the determination that the user is not in a published schedule and/or that the user is not an administrator.

The Modify User Account function allows a user to modify user-specific information. The information that a user has permission to modify will depend on the role that is assigned to that user.

The Change Account Status function allows an administrator or manager to change the status of a user account, toggling between Active and Inactive. This function enables and/or disables access to the system, e.g., log-in capability, from this user account.

A user can change his or her password using the Change Password function. The Password Reset function allows a manager or administrator to reset the password for a user.

The Request Time Off function allows a user, e.g., employee, to submit a request for time off, such as vacation time, from his manager. The system will alert the manager that one of his employees has requested scheduled time off.

The Respond to Time Off Request function allows a manager to respond to a Request Time Off submission by an employee. If the manager approves the Time Off request, then the system will prevent that employee from being scheduled to work during the scheduled time off or vacation period.

The Request Shift Change function allows an employee to request a shift change. Once a request is made, an alert will be sent to all employees that are eligible or permitted to fill the shift, and the shift in question will become an open shift. Additional details regarding employee eligibility to fill shifts is provided below.

Any user who is able and permitted to work a particular shift, e.g., an eligible employee, can accept an open shift in accordance with the Accept Open Shift function. The shift can be opened by a manager, usually manually, or by a requested shift change, automatically.

Every shift change must be approved using the Approve Shift Change function. An administrative user may configure certain job types, discussed below, to have automatically approved shift changes. If a shift change is accepted for a job or job type where automatic approval is not enabled, then a manager must manually approve the shift change through the system, for example, by logging into the system and performing an approval or shift change function.

The Messaging function allows a user to send an intra-system message to and receive an intra-system message from another user. A description of the inventive messaging process and intra-system Messaging Center is provided below.

A user may view a list of important contact information for other users of the system using the View Contact List function.

As indicated above, application functions can perform activities such as scheduling, messaging, alerting, and reporting. The “Scheduling Center” can be the main interface of the inventive application and can consist of a calendar schedule with additional menus and functionality on the surrounding page or on AJAX pop-over windows. The scheduling interface can feature easy to use, drag and drop objects. The Scheduling Center can facilitate all major functionality in the system, including but not limited to the following general tasks: Drag/Drop Time Slot to/from Schedule; Drag/Drop Job to/from Schedule; Drag/Drop User to/from Schedule; Switch Shifts; Request Time Off; Accept Shift; and Emergency Button.

Color, e.g., color-coded screens, etc., enhances the system throughout. For example, both initial scheduling and employee confirmation employ color change on the screens and/or schedules. In one embodiment, when initially scheduling, that is, establishing time slots, jobs, and employee assignments, the color red indicates a schedule that is not complete or not ready to be published. When a schedule is ready to be published, the schedule is yellow. When all employees on a shift are confirmed, the schedule is green. Color can be used for color-based decision making such that the schedule color indicates whether a schedule requires additional attention, e.g., red or yellow, or is complete, e.g., green.

A manager can create a new schedule using the Create Schedule function. The schedule is a time period defined by an administrator or manager. In one embodiment, the manager may choose to create a schedule for one or more of the following blocks of time: Day, Week, Month. The manager may choose to create a blank schedule, to create a schedule based on a template, or create a schedule by copying an existing schedule. A schedule is automatically created in the “Unpublished” state.

The Delete Schedule function allows a manager to delete an unpublished schedule. The Save Schedule function allows a manager to save a schedule without publishing it. The View Schedule function allows any user to view an existing schedule. In one embodiment, the schedules may be viewed using the following filters: Day, Week, Month, Employee, Job, Shift.

The Edit Schedule function allows a manager to edit an existing schedule. Only an unpublished schedule can be edited. The manager must unpublish a published schedule before he can edit the schedule.

A schedule is made up of Time Slots. Generally these are of blocks of workable time, that is, time periods ranging from a few minutes to several hours during which the establishment requires work to be performed. The Add Time Slot to Schedule function allows a manager to add time slots to an existing schedule, and the Remove Time Slot from Schedule function allows a manager to remove a time slot from a schedule. The Remove function can remove or delete any time slots that have been added to the schedule, and this function can be performed with validation. The Save as Template function allows a manager to save a schedule, and all its components including time slots, etc., as a template. The manager can create another schedule from the saved template.

Once a schedule is complete to the manager's satisfaction, it can be published using the Publish function. Publishing sends a message based on preferred communication method to the employees in the schedule, allowing them to view the schedule and request shift changes. Any user can print any schedule that he or she has access to. In addition, an employee and/or a manager can export his or her schedule. In one embodiment, the schedules can be exported in either Excel, PDF, or iCAL standard format.

As discussed above, only unpublished schedules can be edited or changed. If a schedule is published but a change is desired, the Unpublish function unpublishes the published schedule, enabling it to be modified.

Job types or jobs generally define an employee's tasks and/or skills. For example, the job of “bar tender” must be 21 years old or older and must know how to prepare certain kinds of drinks. Using the following functions, manager or an administrator creates the jobs to be performed at his establishment, typically during system set-up. The Add Job function allows a manager or administrator to add a new job. The Edit Job function allows a manager or administrator to edit an existing job. The Delete Job function (with Validation) allows a manager or administrator to delete an existing job. Validation will be enforced to prevent a job that is currently in use from being deleted.

The Assign Employee to Job function allows a manager to assign an existing employee to a job in a particular time slot. This function can include a dynamic search function that provides, e.g., using a pull-down menu, a list of only those employees eligible to fill the job being assigned. The Remove Employee Assignment for Job function allows a manager to remove an employee from a job.

The Auto-Fill function allows the inventive system to automatically select employees to fill all jobs in a particular time slot of a schedule based on defined business logic, such as costs, seniority, and/or random selection. In conjunction with Auto-Fill Schedules and scheduling algorithms, all employees will be responsible for entering information about themselves, their schedule, their work ethic, etc., so that the information can be used in one or more scheduling algorithms. Various algorithms can enable a defined set of criteria to determine which employees are best suited to work in certain time slots. Such scheduling algorithms can allow managers to “Auto-Fill” a schedule, based on defined criteria.

As discussed above, a Time Slot is a pre-defined block of time. A time slot can hold any number of Jobs. Time Slots are manipulated with the following functions. The Create function allows a manager to create a new time slot. A time slot can be created by any of the following sources: blank; from a template; by copying an existing time slot. A manager can put a time slot into edit mode using the Edit function. A time slot that is not in a published calendar can be deleted using the Delete function. A manager can add a job to a time slot and remove a job from a time slot. Validation is performed as part of the remove feature. Removal will remove or delete from the time slot all employees that had been marked to fill the job(s) in the removed time slot.

The Save As Template function allows a manager to save the time slot and any jobs and/or employees that have been added to it, as a template for use in the future.

As indicated above, additional system features include alerting, reporting, and application security. Alerting includes the following functions. The Email function allows the system to generate a scripted email alert, and the Text Message function allows the system to generate a scripted text message alert. For each alertable event, a user may choose Text Messaging or Email Notification as the desired notification or preferred communication option.

An intra-system Messaging Center can allow users to communicate with each other and with the scheduling system via email, web-announcement or text message. This unique Messaging Center process enables users to communicate through the inventive system, eliminating the need to go “off-line” or out of the system's structure. The system propagates messages using email addresses and/or carrier domain gateways, providing scalability and cost efficiency to all users. In addition, message tracking can be performed. Although a message is initiated in the web application, users can communicate through the Messaging Center using email or SMS. All messages are also available in the user's messaging section. The Messaging Center process is described in more detail below.

The Messaging Center can allow a user to accomplish the following general tasks: send an email/text message to a user in the system; post an announcement to the web-based message board; and respond to a scheduling request via text message. AJAX-Enabled menus and windows can be used to give users a “Desktop Application Experience” in a web-based environment.

Alerting includes events for both employees, Alertable Employee Events, and managers, Alertable Manager Events. One or more of the following system events can generate an alert to one or more employees, each alert sent to the employee by his or her preferred communication method. The events include: a new schedule is published; an unconfirmed shift exists; a previously filled shift becomes open; a shift that the employee released becomes filled. Further, managers can cause one or both of the following events to generate an alert: a shift change occurs; an employee requests time off. In one embodiment, a manager can override the employee's preferred communication method and require a particular message to be sent only via email or text.

In addition, any user may have an alert generated in response to an event of an intra-system message. This can be an Alertable General Event. The system is not limited to the above alertable events; alerts can be generated in response to other events as appropriate. For example, an alert can be generated when an employee sends a message asking for an additional shift of work.

A number of predefined reports can be displayed. Access to these reports will be based on the user's role.

Application Security features can be provided, including an Authenticate Web Users function requiring a Unique Username and Password. This function allows a user to log-in to the inventive system using a unique user id, password and location. In one embodiment, the same user cannot be logged in at multiple locations.

The main user interaction with the inventive system can occur via web pages. These pages can utilize advanced client side scripting to enable drag and drop behavior. Users will have access to the application's full feature set through the web interface.

Users can also interact with the system through email. In one embodiment, this interaction can only occur if prompted by a system event sending the user an email. Hyperlinks can be encoded within the email, and a user may click on one of the hyperlinks to interact with the system.

Additionally, users can interact with the application through text messaging. In one embodiment, this interaction can only occur if prompted by a system event sending the user a text message. Users may respond to that message with another text message. In another embodiment, a user can initiate interaction with the application by texting a message into the system.

Operation of the system according to an exemplary embodiment is now described.

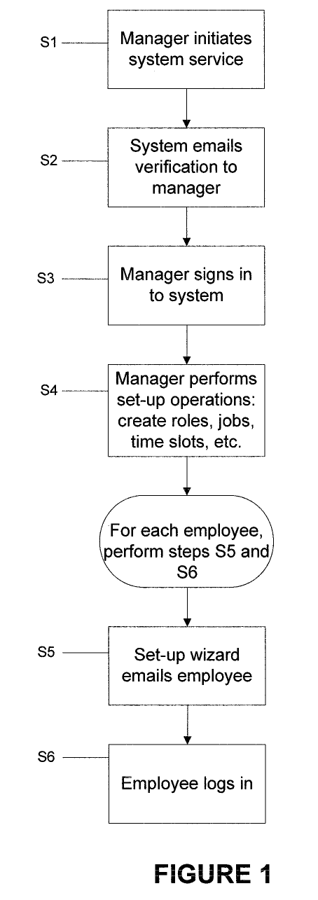

Initially, system set-up is performed to enter an establishment into the system. FIG. 1 is a flow diagram of system set-up of the inventive method. In step S1, a manager initiates service by creating a user ID including log-in and password. The manager can accept the “terms of use” and perform additional installation services as desired. In step S2, the system emails the manager verifying that his or her account has been set-up. The manager logs in to the system using his user ID in step S3. In step S4, the manager performs operations such as selecting hours of operation and time zone, assigning jobs with corresponding icons, blocking time shifts, setting communication defaults and alert timing, etc. A set-up wizard can assist with these operations.

In step S5, the set-up wizard can request name, email address, and job qualifications for each employee, and can send an email to each employee, associating him or her with the system. In step S6, each employee receives the email sent by the manager and/or the set-up wizard, clicks on the link in the email to connect to the system's web site, logs in, and enters personal contact information, schedule availability, and messaging preferences. In one embodiment, the employee is prompted for this information. In another embodiment, the employee enters the required data onto a form.

Additional employees can be added by repeating steps S5 and S6.

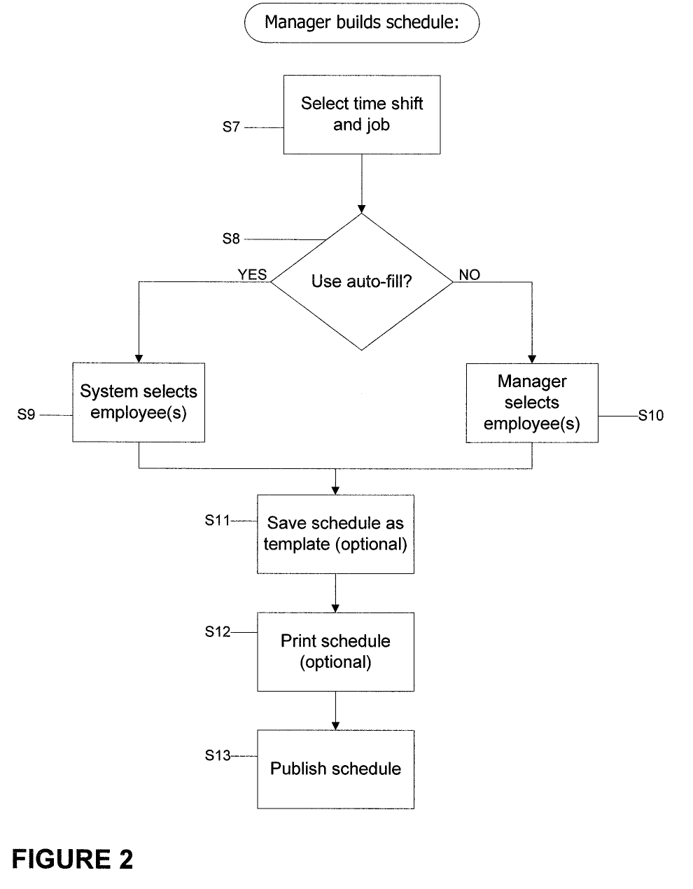

On-going operation of an exemplary embodiment of the system is shown in the flow diagram in FIG. 2, which illustrates the scheduling process performed by a manager. Initially, a manager begins to build a schedule. This can be done by selecting the day view of the schedule screen. In step S7, a time shift and a job for that time shift is selected. The manager indicates, in step S8, whether the schedule will be created by the auto-fill function. If auto-fill is selected (S8=YES), the employee(s) for the job and time shift are chosen by the system in step S9 and the process continues at step S11. The techniques for choosing employees can include various processes and/or algorithms and can incorporate information obtained from the employees' user accounts.

If auto-fill is not selected (S8=NO), the manager selects the employee(s) for the job and time shift in step S10 and the process continues at step S11.

In step S11, the manager can choose to save the schedule as a template. The manager can choose to print the schedule in a variety of formats in step S12. In step 13, the manager publishes the schedule, triggering the sending of a message to employees that a schedule has been published. The message is sent in accordance with the employee's preferred communication mode, e.g., preference of email or text. In one embodiment, publishing the schedule causes it to change from red to yellow.

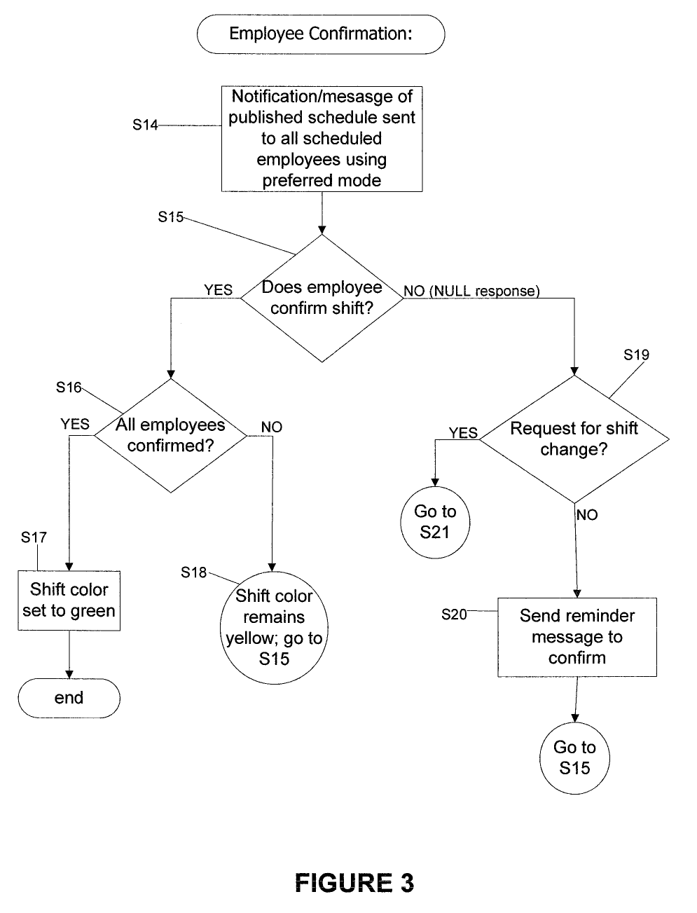

The employee confirmation portion of the process is shown in the flow diagram of FIG. 3. In step S14, each employee on the schedule published in step S13 receives the message stating that a schedule is published and providing a link for viewing the schedule. In response to the message, in step S15, an employee logs in and responds to his or her shift(s) on the published schedule. If the employee confirms his shift (S15=YES), and if all scheduled employees have confirmed the shift (S16=YES), the shift color on the schedule will be set to green in step S17. Accordingly, a shift changes from yellow to green when all of the employees on that shift have confirmed their availability.

If one employee confirms the shift (S15=YES), but not all employees are confirmed (S16=NO), then in step S18 the shift color remains yellow and processing continues, e.g., confirmation from additional employees is awaited, in step S15.

If an employee does not confirm his or her shift (S15=NO), the employee may, in some circumstances, request a shift change. Note that if a shift change request is not permitted, the option to request such a change will not be offered to the employee. If a shift change is requested (S19=YES), processing continues at step S21, discussed below. If a shift change is not requested (S19=NO), at step S20 a reminder to confirm his shift is sent to the employee. Processing continues at step S15.

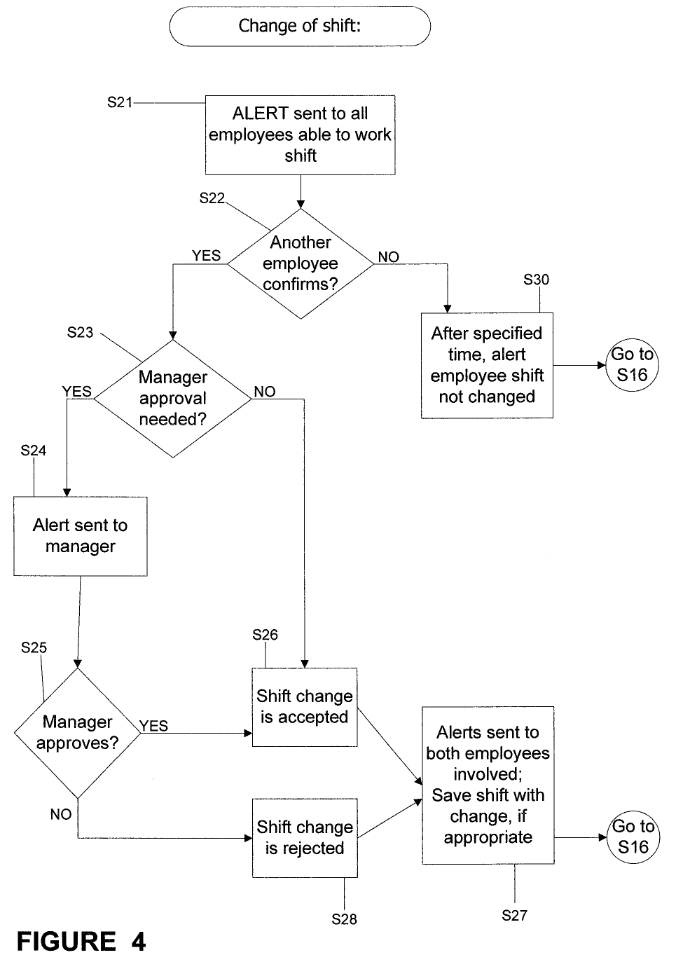

The change of shift portion of the process is shown in the flow diagram of FIG. 4. When an employee requests a shift change (S19=YES), an opening or open shift occurs. In step S21, an alert is sent to all eligible employees regarding the opening. Eligible employees are those qualified to work the opening, such as those available to work the time of the shift and/or those having the same job and/or role as is needed for the opening. In some situations, an otherwise eligible employee might not be eligible because of workplace constraints, such as number of hours scheduled in one day, amount of overtime scheduled in one pay period, etc.

If an eligible employee confirms that he or she can work the open shift (S22=YES), and if manager approval is needed for the shift change (S23=YES), then an alert is sent to the manager in step S24. If the manager approves (S25=YES), then the shift change is accepted in step S26. Typically, the employee requesting a shift change is replaced with the eligible employee in the schedule. In step S27, alerts are sent to both employees (the one requesting the change and the one accepted to fill the opening), and the changed shift can be saved. Processing continues at step S16.

If the manager does not approve the shift change (S25=NO), the shift change is rejected in step S28, both employees are alerted in step S27, and, if appropriate, the shift change can be saved. Processing continues at step S16.

If manager approval is not needed (S23=NO), the shift change is accepted in step S26, alerts are sent to both employees and the changed shift can be saved in step S27. Processing continues at step S16.

If no eligible employee confirms the opening (S22=NO), then after a specified time, the employee is alerted that his request for a shift change has not been accepted in step S30. Processing continues at step S16.

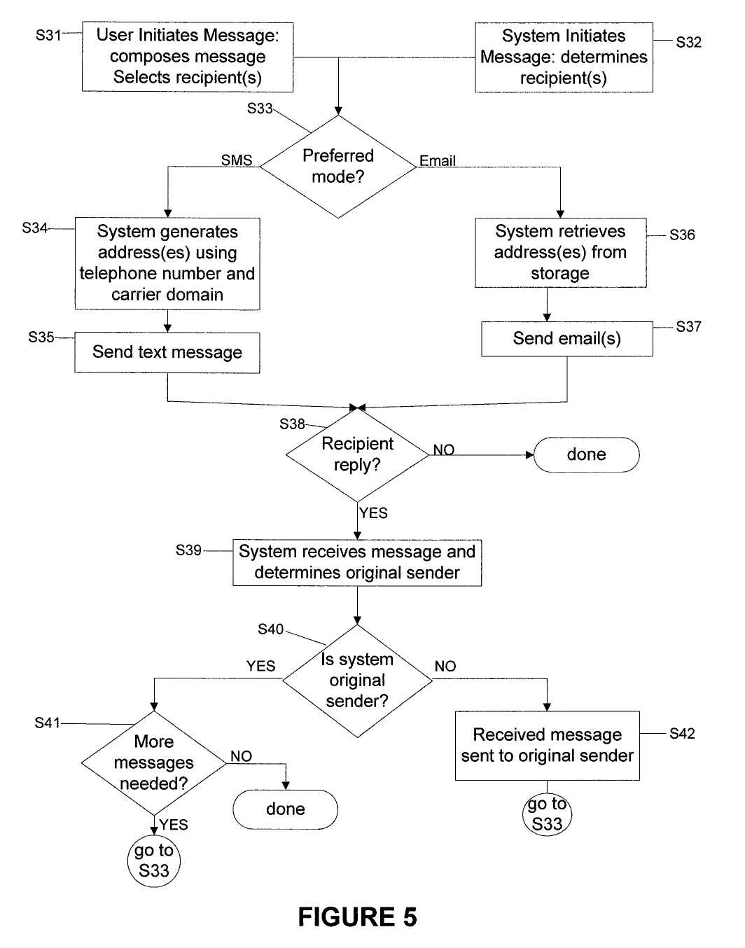

The operation of the Messaging Center in one embodiment of the inventive system is shown in a flow diagram in FIG. 5. Generally there are two ways a message chain is started, either by a user or by the system. A user can initiate a message to either other users or to an administrator, to commence a message chain. The message to an administrator can be a “next shift” option regarding the user's next, published, shift.

A user initiated message chain begins by a user logging on to the web application and navigating to the messaging section. In step S31, the user creates a new message and adds one or more recipients to the message. When the user clicks the send button, the system sends the message to each recipient on the recipient list using steps S33-S37.

In step S32, the system (as opposed to a user) generates and sends messages to particular users. Some of these messages are interactive. Generally, when a message is generated by the system, the TO and FROM addresses for the message are generated as described below, and the preferred mode of each TO address is checked in step S33 and the message is sent as described in steps S34-S37.

In particular, in step S33, each recipient's preferred communication mode is determined. If the recipient's preferred mode is text or SMS (S33=SMS), processing continues at step S34, in which the system generates the TO and FROM addresses. Detail about creation of these addresses is provided below. In step S35, the text message is sent. If the preferred mode is email (S33=EMAIL), processing continues at step S36, in which the system retrieves the recipient's email address from the recipient's user preferences saved in the system. In step S37, the email message is sent.

In step S38, the system determines whether a recipient has replied to the message. If no reply is received (S38=NO), the Message Center operation is done. However, when a recipient responds or replies to a message (S38=YES), the system performs steps S39-S42. In step S39, the original sender of the response message is determined as follows. The response is received in the system by a “Catch All” account. The message's TO address is parsed and all data in this address is stored in the system, so that the original sender can be determined. The FROM address is created based on the logic described below. Based on the response of the user, the system may send additional messages to other users, as well as a confirmation message to the sending user.

If the original sender is the system (S40=YES), then the system checks whether one or more messages, such as a response to the reply message, are needed. If additional messages are needed (S41=YES), then the required reply is determined, including the TO address, and processing continues in step S33. Otherwise, if no additional messages are needed (S41=NO), processing is done.

If the system was not the sender of the original message (S40=NO), the system then forwards the reply or response message to the original sender based on the original sender's preferred communication method in step S33.

The system determines the TO Addresses as follows. To send a message to a user, the system determines whether the user's preferred communication method is text, e.g., SMS, or email. If the user's preferred communication method is SMS, when the user desires to send a message, the system creates a TO email address by combining the user's mobile telephone number with the appropriate carrier domain. For example, if the user's number is 888-123-4567, and his carrier is at&t, then the TO address “8881234567@txt.att.net” is created. In the alternative, if the user's preferred communication method is email, then the system uses his email address stored in the system as the TO address.

The system determines the FROM Addresses as follows. All FROM addresses can be part of an exclusive system domain, e.g., system.readysetwork.net. Each FROM address consists of a set of identifiers indicating the sender's employee ID, the receiver's employee ID, establishment ID, and message chain ID. The message chain ID can be a number grouping interactive messages.

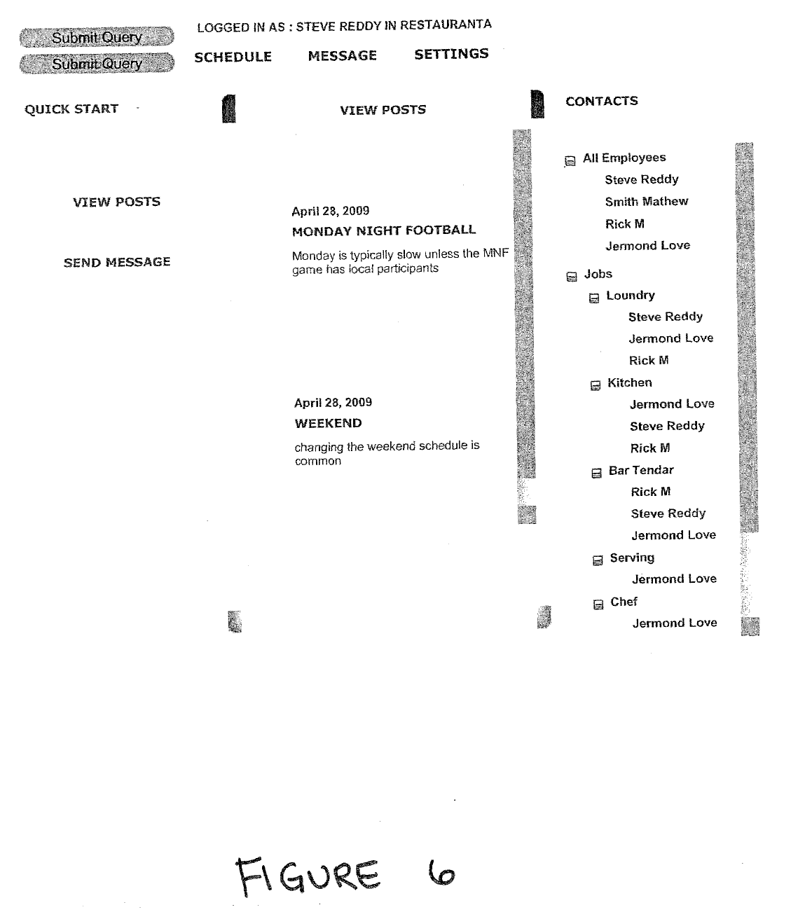

FIG. 6 shows an exemplary web screen of messaging as user posts. The column on the right, CONTACTS, shows users who can be added as recipients for a message. For example, these recipients can be individuals or members of a group such as Jobs. Recipients can be added using “drag and drop” of either an individual or a group or both.

The various functionalities and modules of the systems and methods of the present disclosure may be implemented or carried out distributedly on different processing systems or on any single platform, for instance, accessing data stored locally or distributedly on the network.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A method for scheduling a plurality of employees, comprising steps of:
creating a schedule having a plurality of time slots comprising shifts, each shift having one employee of said plurality of employees;
publishing said schedule on a two-way communication network to each of said plurality of employees; and
receiving a response from each employee, wherein said response is one of a confirmation, a request for shift change, and a null response, and for each employee:
if the null response is received, sending a reminder to said employee, and
if the confirmation is received, saving the confirmation in the schedule, and
if the request for shift change is received, performing the steps of:
sending an alert to one or more eligible employees of said plurality of employees using a preferred communication mode of each of said eligible employees;
if one of the eligible employees responds and if manager approval is needed, alerting the manager and if the manager approves, changing and saving the shift as the confirmation in the schedule and alerting the employee and the eligible employee, and if the manager does not approve, alerting the employee and the eligible employee; and
if one of the eligible employees responds and if manager approval is not needed, changing and saving the shift as the confirmation in the schedule and alerting the employee and the eligible employee.

2. The method according to claim 1, wherein said shifts change color in accordance with a three-step color-coding scheme.

3. The method according to claim 1, said step of creating comprising steps of:
establishing one or more jobs and the plurality of time slots; and
assigning at least one employee to each shift based on a job of the employee.

4. The method according to claim 3, wherein said step of assigning is performed using an auto-fill feature.

5. The method according to claim 1, wherein said communication network is web-based.

6. The method according to claim 1, wherein said step of publishing is performed by sending an alert to each employee using a preferred communication mode of said employee.

7. The method according to claim 1, wherein said step of publishing comprises changing a color of said schedule.

8. The method according to claim 1, wherein said response is sent on the communication network.

9. A computer readable medium having computer readable program for operating on a computer for scheduling a plurality of employees, said program comprising instructions that cause the computer to perform the steps of:
creating a schedule having a plurality of time slots comprising shifts, each shift having one employee of said plurality of employees;
publishing said schedule on a two-way communication network to each of said plurality of employees; and
receiving a response from each employee, wherein said response is one of a confirmation, a request for shift change, and a null response, and for each employee:
if the null response is received, sending a reminder to said employee, and
if the confirmation is received, saving the confirmation in the schedule, and
if the request for shift change is received, performing the steps of:
sending an alert to one or more eligible employees of said plurality of employees using a preferred communication mode of each of said eligible employees;
if one of the eligible employees responds and if manager approval is needed, alerting the manager and if the manager approves, changing and saving the shift as the confirmation in the schedule and alerting the employee and the eligible employee, and if the manager does not approve, alerting the employee and the eligible employee; and
if one of the eligible employees responds and if manager approval is not needed, changing and saving the shift as the confirmation in the schedule and alerting the employee and the eligible employee.

10. The program according to claim 9, wherein said shifts change color in accordance with a three-step color-coding scheme.

11. The program according to claim 9, said step of creating comprising steps of:
establishing one or more jobs and the plurality of time slots; and
assigning at least one employee to each shift based on a job of the employee.

12. The program according to claim 11, wherein said step of assigning is performed using an auto-fill feature.

13. The program according to claim 9, wherein said communication network is web-based.

14. The program according to claim 9, wherein said step of publishing is performed by sending an alert to each employee using a preferred communication mode of said employee.

15. The program according to claim 9, wherein said step of publishing comprises changing a color of said schedule.

16. The program according to claim 9, wherein said response is sent on the communication network.

17. A system for scheduling a plurality of employees, comprising:
a plurality of time slots having a plurality of time slots comprising shifts, each shift having one employee of said plurality of employees
a schedule having the plurality of time slots;
a two-way communication network publishing said schedule to each of said plurality of employees; and
a response received from each employee, wherein said response is one of a confirmation, a request for shift change, and a null response, and for each employee:
if the null response is received, sending a reminder to said employee, and
if the confirmation is received, saving the confirmation in the schedule, and
if the request for shift change is received, performing the steps of:
sending an alert to one or more eligible employees of said plurality of employees using a preferred communication mode of each of said eligible employees;
if one of the eligible employees responds and if manager approval is needed, alerting the manager and if the manager approves, changing and saving the shift as the confirmation in the schedule and alerting the employee and the eligible employee, and if the manager does not approve, alerting the employee and the eligible employee; and
if one of the eligible employees responds and if manager approval is not needed, changing and saving the shift as the confirmation in the schedule and alerting the employee and the eligible employee.

18. The system according to claim 17, wherein said shifts change color in accordance with a three-step color-coding scheme and said communication network is web-based.

19. The system according to claim 17, further comprising one or more jobs wherein at least one employee is assigned to each shift based on a job of the employee.

20. The system according to claim 17, further comprising a preferred communication mode of said employee, wherein an alert of publishing of the schedule is sent to each employee using the preferred communication mode of said employee.
